(19) United States
(12) Patent Application Publication
(10) Pub. No.: US 2013/0103527 A1
(43) Pub. Date: Apr. 25, 2013

(54) APPARATUS AND METHOD FOR INSTALLING DIGITAL PRODUCT

(71) Applicant: Samsung Electronics Co., Ltd, Gyeonggi-do (KR)

(72) Inventors: Chi-Hyun Cho, Seoul (KR); Jin-Wook Lee, Gyeonggi-do (KR); Jeong-In Kim, Gyeonggi-do (KR)

(73) Assignee: Samsung Electronics Co., Ltd, Gyeonggi-do (KR)

(21) Appl. No.: 13/655,997

(22) Filed: Oct. 19, 2012

(30) Foreign Application Priority Data
Oct. 21, 2011 (KR) 10-2011-0108144

(51) Int. Cl. G06Q 30/00

(52) U.S. Cl. 705/26.1

(57) ABSTRACT

A method and apparatus of a device for remotely installing a digital product. The method includes purchasing, at a first device accessing a server, at least one digital product stored to the server. The method also includes requesting the server to transmit the purchased digital product to at least one second device.

### CROSS-REFERENCE TO RELATED APPLICATION(S) AND CLAIM OF PRIORITY

The present application is related to and claims the benefit under 35 U.S.C. §119(a) to a Korean Patent Application filed in the Korean Intellectual Property Office on Oct. 21, 2011 and assigned Serial No. 10-2011-0108144, the entire disclosure of which are hereby incorporated by reference

### TECHNICAL FIELD OF THE INVENTION

The present disclosure relates generally to digital products. More particularly, the present disclosure relates to an apparatus and method for installing a digital product.

### BACKGROUND OF THE INVENTION

As computing device technology advances, users can have more opportunities to purchase various digital products online. For example, applications for smart phones, smart televisions, and Personal Computers (PCs) are developed and sold in online markets.

However, conventional online markets are typically operated as separate markets according to types of a device and a platform. For example, applications for the smart phone are available in a smart phone market, and applications for the PC are available in a PC market.

Typically, it is necessary to access an online market suitable for the device type and platform of the user. Since a technique for transmitting a digital product to a device not directly accessing the online market is not yet developed, the user who wants to purchase the digital product needs to access the online market in person.

### SUMMARY OF THE INVENTION

To address the above-discussed deficiencies of the prior art, it is a primary aspect of the present disclosure to provide an apparatus and a method for enhancing user's convenience by operating an integrated market regardless of a type and a platform of a device.

Another aspect of the present disclosure is to provide an apparatus and a method for, when a device accessing a server purchases a digital product and selects a device for installation, installing the digital product to the installation device regardless of whether the installation device is accessing the server.

Yet another aspect of the present disclosure is to provide an apparatus and a method for enhancing user's convenience by interoperating an integrated market of the present disclosure and a conventional online market.

Other aspects, advantages, and salient features of the disclosure will become apparent to those skilled in the art from the following detailed description, which, taken in conjunction with the annexed drawings, discloses exemplary embodiments of the disclosure.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a relationship between purchase and installation devices and a server according to an embodiment of the present disclosure;

FIGS. 2A and 2B illustrate a method of a device for obtaining an access right from the server according to an embodiment of the present disclosure;

FIG. 3 illustrates a method of the server requested by the purchase device to transmit a digital product to the installation device, for transmitting the digital product to the installation device according to an embodiment of the present disclosure;

FIG. 4 illustrates a method of the purchase device for accessing the server and receiving information of the installation device from the server according to an embodiment of the present disclosure;

FIGS. 5A through 5C illustrate the search for the device and the installation device registered to the server according to an embodiment of the present disclosure;

FIG. 6 illustrates operations of the purchase device for purchasing the digital product according to an embodiment of the present disclosure;

FIG. 7 illustrates operations of the installation device for installing the digital product according to an embodiment of the present disclosure;

FIG. 8 illustrates operations of the server for installing the digital product according to an embodiment of the present disclosure;

FIG. 9 illustrates the device for purchasing and installing the digital product according to an embodiment of the present disclosure; and

FIG. 10 illustrates the server for installing the digital product according to an embodiment of the present disclosure.

Throughout the drawings, like reference numerals will be understood to refer to like parts, components and structures.

### DETAILED DESCRIPTION OF THE INVENTION

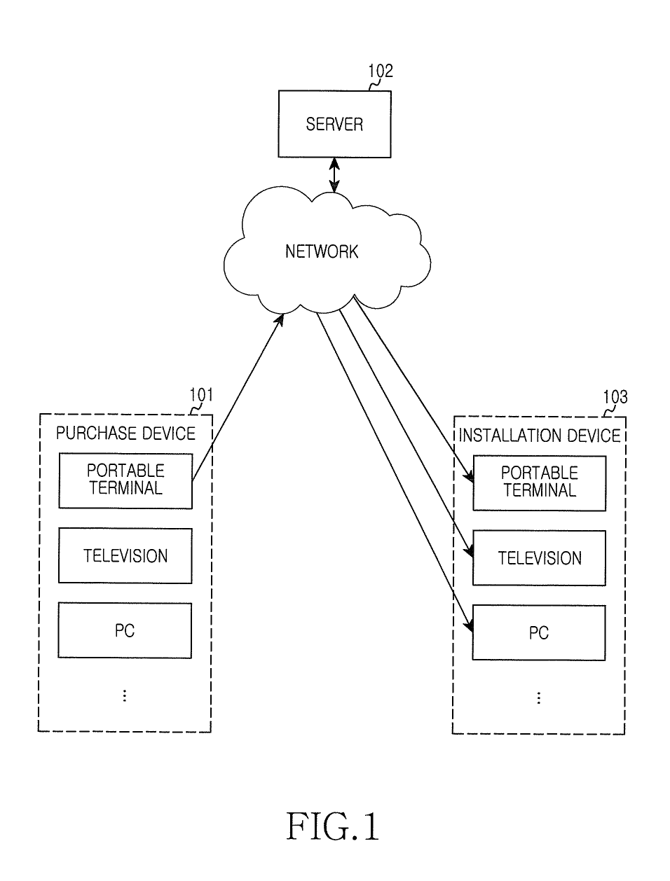

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. The following description with reference to the accompanying drawings is provided to assist in a comprehensive understanding of exemplary embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of exemplary embodiments of the present disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

FIG. 1 depicts a relationship between purchase and installation devices and a server according to an embodiment of the present disclosure. As shown in FIG. 1, the purchase device 101 indicates a device which accesses the server 102 and purchases a digital product stored to the server 102. For example, the purchase device 101 can employ any device, such as a portable terminal, television, and PC, capable of accessing the server 102 and purchasing the digital product from the server 102. The purchase device 101 can select at least one installation device 103 and request the server 102 to install its purchased digital product to the installation device 103. Notably, the purchase device 101 can purchase a digital product stored to the server 102 and install the digital product directly to the purchase device 101. Herein, the digital product represents any product the server 102 deals in online. For example, the digital product can include various contents and applications.

The server 102 indicates a device operated by a person or entity that sells the digital products online. The server 102 receives the digital product from a digital product seller and stores the received digital product. As stated earlier, the purchase device 101 can access the server 102 and purchase the digital product stored to the server 102, and the server 102 can receive the installation request from the purchase device 101 to install the digital product purchased by the purchase device 101 to the installation device 103. The server 102 receiving the installation request from the purchase device 101 installs the digital product purchased by the purchase device 101 to the installation device 103. The server 102 collectively manages all the digital products regardless of the type and the platform of the device. In more detail, the digital products stored to the server 102 can be sold to the device regardless of the type and the platform of the device accessing the server 102. For example, when the purchase device 101 is a smart phone, the server 102 can sell not only a smart phone application but also television and PC applications to the smart phone. That is, the server 102 can integrate and store all the applications for the smart phone, the television, and the PC, and thus sell the digital products regardless of the type and the platform of the purchase device 101.

The installation device 103, which is selected by the purchase device 101, indicates a device for receiving the digital product purchased by the purchase device 101 from the server 102. For example, the installation device 103 can employ any device, such as a portable terminal, television, and PC, capable of receiving the digital product from the server 102. More specifically, the installation device 103 can receive the digital product purchased by the purchase device 101 from the server 102, regardless of the access to the server 102. When the purchase device 101 purchases a digital product stored to the server 102 and installs the digital product directly to the purchase device 101, the installation device 103 is the purchase device 101. That is, the installation device 103 can flexibly alter according to the situation.

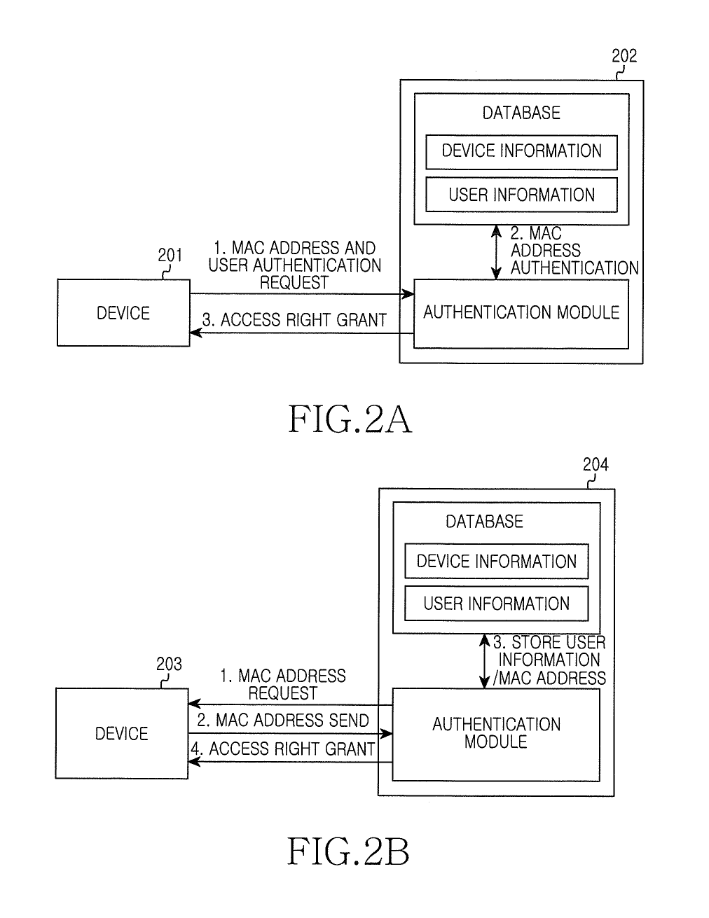

FIGS. 2A and 2B depict a method of a device for obtaining an access right from the server according to an embodiment of the present disclosure. FIG. 2A depicts the access right granted by the server using a Media Access Control (MAC) address and user information of the device. As shown in FIG. 2A, the MAC address and the user information of a device 201 can be used for a server 202 to grant the access right to the device 201. The MAC address indicates a physical address allocated to a Local Area Network (LAN) card embedded in the device such as a portable terminal and PC. Hence, with the MAC address of the device, it is possible to obtain necessary information of the corresponding device. The user information indicates information of the user who tries to access the server 202 using the device. For example, the user information can include an identifier (ID) or a password input by the user.

To grant the access right from the server 202 to the device 201, the MAC address and the user information of the device 201 can be used in an embodiment. In detail, the device 201 attempting to access the server 202 requests MAC address authentication and user authentication of the device 201 to the server 202. The server 202 receiving the MAC address authentication request and the user authentication request from the device 201, reads the MAC address of the device 201 from the device 201 and receives the user information. The server 202 reading the MAC address of the device 201 and receiving the user information stores the device information and the user information to its database, and grants the access right to the device 201. When the device 201 acquires the access right from the server 202, the authentication of the device 201 to access the server 202 is finished.

In FIG. 2B, the device acquiring the access right from the server attempts to access the server. As shown in FIG. 2B, when a device 203 acquiring the access right from a server 204 attempts to access the server 204 again, the server 204 requests a MAC address of the device 203 to the device 203. The device 203 receiving the MAC address request from the server 204 transmits its MAC address to the server 204. The server 204 receiving the MAC address from the device 203 compares device information pre-stored to its database with the MAC address received from the device 203. That is, the server 204 determines whether the device 203 trying to access the server 204 corresponds to the device information pre-stored to its database. When the device information pre-stored to the database of the server 204 matches the MAC address received from the device 203, the server 204 grants the access right to the device 203. That is, when the device 201 initially attempts the access to the server 202, the access right is granted to the device 201 through the MAC address authentication and the user authentication of the device 201 as mentioned above. By contrast, when the device 203 acquiring the access right tries to access the server 204, only the MAC address of the device 203 attempting the access is read and the access right is granted when the MAC address matches the device information stored to the database of the server 204.

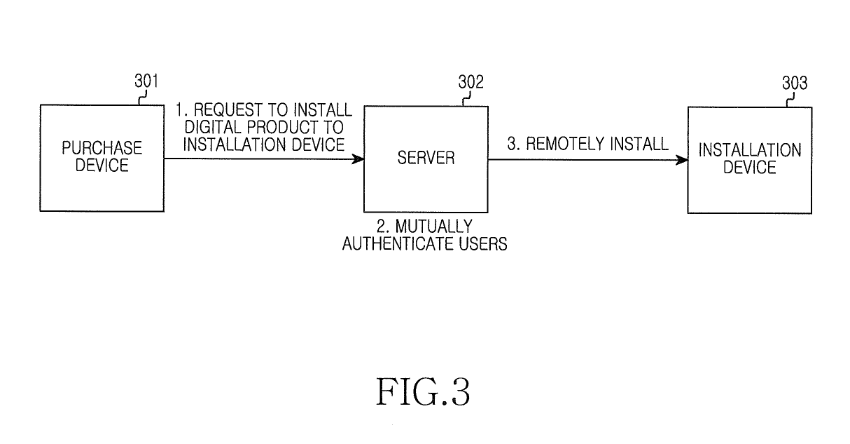

FIG. 3 illustrates a method of the server requested by the purchase device to transmit a digital product to the installation device, for transmitting the digital product to the installation device according to an embodiment of the present disclosure. As shown FIG. 3, a purchase device 301 accesses a server 302 and purchases at least one digital product stored to the server 302. The purchase device 301 purchasing at least one digital product stored to the server 302 searches for an installation device 303 to install the purchased digital product. In detail, the purchase device 301 can search for a user of the installation device 302 pre-stored to at least one of a phone book list and a social network of the purchase device 301. That is, the purchase device 301 can search for and select at least one user of the installation device 303 pre-stored to the phone book list of the purchase device 301. Alternatively, the purchase device 301 may search for and select the user of the installation device 303 pre-stored to the social network.

After searching for and selecting the installation device 303, the purchase device 301 requests the server 302 to transmit its purchased digital product to the installation device 303. The server 302 receiving the installation request from the purchase device 301 performs mutual authentication. The mutual authentication determines whether the purchase device 301 and the installation device 303 each pre-store the user of the installation device 303 and the user of the purchase device 301. For example, the mutual authentication determines whether at least one of the phone book list and the social network of the purchase device 301 pre-stores the user of the installation device 303, and determines whether at least one of the phone book list and the social network of the installation device 303 pre-stores the user of the purchase device 301. The server 302 conducts the mutual authentication in order to prevent the unilateral digital product installation from the purchase device 301 to the installation device 303. When the server 302 does not perform the mutual authentication, the installation device 303 may receive an unintended digital product. Thus, in some embodiments, the mutual authentication is important.

When completing the mutual authentication, the server 302 transmits the digital product purchased by the purchase device 301 to the installation device 303. More specifically, before transmitting the digital product purchased by the purchase device 301 to the installation device 303, the server 302 sends a message relating to the reception. That is, even when the server conducts the mutual authentication, an unintended digital product can be installed to the installation device 303 as described above. Hence, the server 302 sends the message relating to the reception to the installation device 303. Upon receiving a message indicating the reception from the installation device 303, the server 302 finally transmits the digital product purchased by the purchase device 301 to the installation device 303.

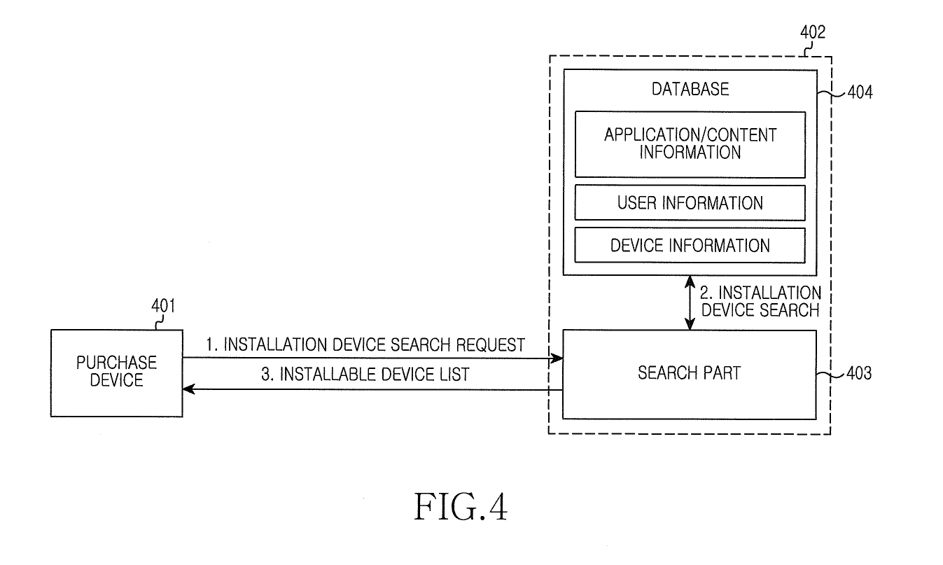

FIG. 4 illustrates a method of the purchase device for accessing the server and receiving information of the installation device from the server according to an embodiment of the present disclosure. As explained in FIGS. 1, 2 and 3, a purchase device 401 accesses a server 402 and purchases at least one of a number of digital products stored to the server 402. Next, the purchase device 401 selects at least one of a number of users of the pre-stored installation devices. Next, the purchase device can request information of the installation device to the server 402. For example, the information of the installation device can include hardware specifications, version, platform, and type of the installation device. When the digital product purchased by the purchase device 401 is to be installed to the installation device, it needs to be a digital product installable to the installation device. That is, such information is requested to determine whether the digital product purchased by the purchase device 401 is suitable for the installation device.

After the purchase device 401 requests the information of the installation device to the server 402, a search part 403 of the server 402 searches for the installation device pre-stored to a database 404 of the server 402. The database 404 of the server 402 stores not only information of the digital products stored to the server 402 but also the device information and the user information of the purchase device 401 and the installation device. In further detail, to acquire the access right, the device accessing the server 402 passes through the MAC address and user information authentication of the access device. That is, both the purchase device 401 and the installation device pass through the authentication of the server 402 and acquire the access right from the server 402. Hence, through the initial authentication, the database 404 of the server 402 pre-stores the digital product information, the user information, and the device information of the purchase device 401 and the installation device.

The search part 403 of the server 402 searches for the installation device information pre-stored to the database 404 of the server 402, and provides the installation device information to the purchase device 401 which requests the installation device information. As such, the purchase device 401 can receive the installation device information through the server 402. Next, the user of the purchase device 401 can read the installation device information and then determine whether the purchased digital product is suitable for the installation device. More specifically, the market managed through the server 402 is the integrated market storing various digital products. That is, the market collectively stores all of the digital products including smart phone applications, smart television applications, and PC applications. For example, it is assumed that the purchase device 401 is a smart phone that purchases a television application stored to the server 402. The purchase device 401 can select the user of the installation device and thus request the information of the device used by the user of the installation device, to the server 402. The purchase device 401 can receive the device information of the television among the installation devices, from the server 402. Next, the user of the purchase device 401 can receive the device information of the television from the server 402 and thus determine whether the purchased television application is adequate for the television which is the installation device.

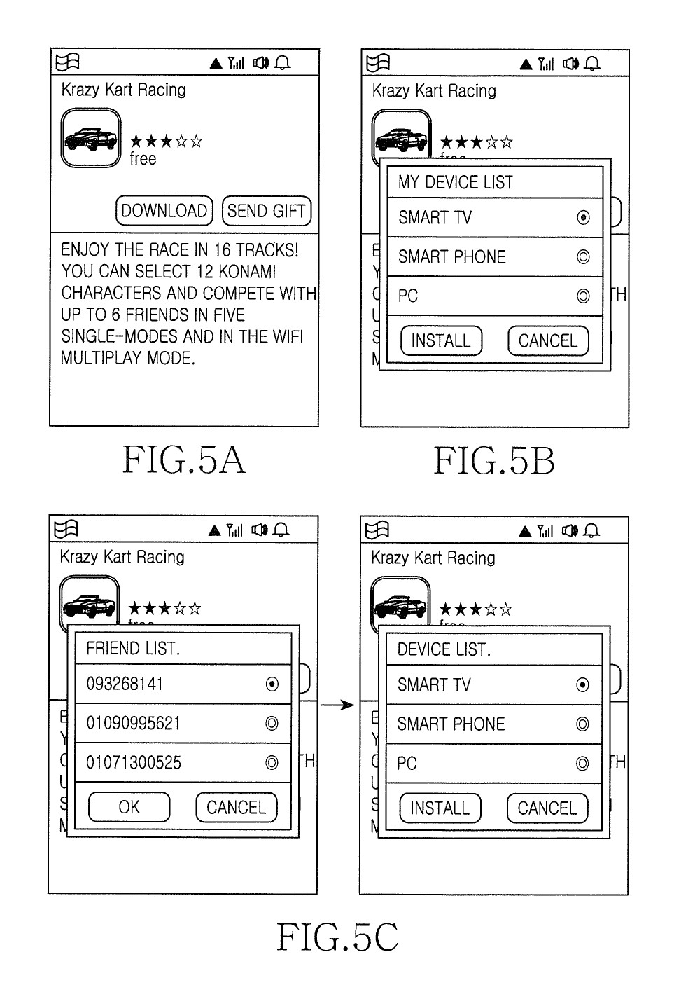

FIGS. 5A through 5C illustrate the search for the device and the installation device registered to the server according to an embodiment of the present disclosure. FIG. 5A depicts that the application is installed directly to the purchase device. It is assumed that the purchase device purchases a particular application stored to the server as shown in FIG. 5A. That is, the purchase device is a smart phone, and the purchased application is a smart phone application. The smart phone which is the purchase device can install the purchased smart phone application directly to the purchase device. In detail, the smart phone can select “Download” and install the application directly to the installation device. When the application purchased by the purchase device is installed directly to the purchase device, there is no need to pass through the authentication in the server as stated earlier. In other words, when the application purchased by the purchase device is installed to the application device, it is necessary to authenticate the purchase device and application device in the server. However, when the application purchased by the purchase device is installed directly to the purchase device in FIG. 5A, the application can be installed immediately to the purchase device without the authentication of the server.

The purchase device purchasing the application stored to the server may install the application directly to the purchase device by selecting “Download”, or may install the application to the installation device by selecting “Send gift”. In more detail, the user of the purchase device can select “Send gift”, search for and select the installation device, and install the application to the selected installation device. That is, when the user of the purchase device selects “Send gift”, the application purchased by the purchase device is installed to the installation device through the server's authentication as mentioned above.

FIG. 5B depicts the search for a device list stored to the server. The device user can read the device list pre-stored to the server. For example, when the device stored to the server is a smart television, a smart phone, or a PC, the device user can search for and read the device list stored to the server. That is, the user can obtain the list of the devices including a smart television, smart phone, and PC registered to the server. Hence, after reading the current device list registered to the server of the integrated market, the user may add a new device or delete a particular one of the registered devices. The device's registration in the device list implies that a digital product can be installed to the registered device. The server can install the digital product to the smart television, the smart phone, and the PC registered to the server as shown in FIG. 5B. Thus, the device user can search for its device list and identify the devices registered to the server and the device for the current application at the same time.

FIG. 5C depicts the search for an installation device list registered to the server. In detail, when the purchase device purchasing the digital product wants to install the purchased digital product to the installation device, it can search for a friend device list stored therein. For example, it is assumed that a television application stored to the server is purchased using a smart phone. When the smart phone intends to install the purchased television application to the installation device, the smart phone can search for the user of the installation device in the phone book list stored therein. Phone numbers of several installation device users are registered to the phone book list of the user as shown in FIG. 5C. When the user selects the user of the phone number “093268141” from the phone numbers registered to the phone book list of the user, the user can read the installation device list of the user of the phone number “093268141” in the next screen. That is, the user can see the list of the devices pre-stored to the server among the devices of the selected user. The list of the installable devices of FIG. 5C registers the smart television, the smart phone, and the PC. The user can select the smart television among the registered devices and install the television application purchased by the purchase device to the smart television of the user of the phone number of “093268141”.

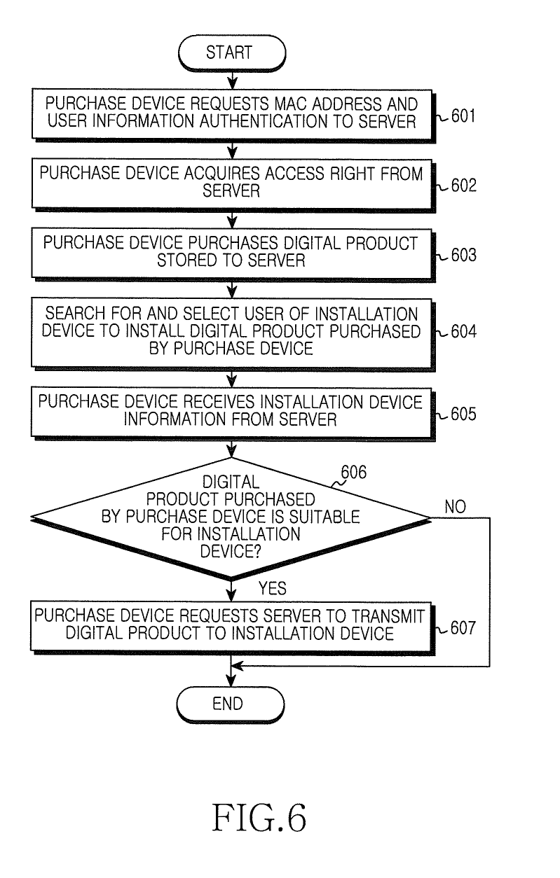

FIG. 6 illustrates operations of the purchase device for purchasing the digital product according to an embodiment of the present disclosure. As shown in FIG. 6, the purchase device requests the MAC address and user information authentication to the server in block 601. In detail, to access the server, the device passes through an authentication. Herein, the MAC address and the user information authentication of the purchase device are used. Herein, the purchase device purchases the digital product by accessing the server and selecting to install the purchased digital product to the installation device. Although it is not illustrated in FIG. 6, as the devices for using the integrated market, both the purchase device for purchasing the digital product and the installation device selected by the purchase device should pass through the authentication of the server. Accordingly, both of the purchase device and the installation device should acquire the access right through the authentication of the server.

Next, the purchase device acquires the access right from the server in block 602. Once the purchase device acquires the access right from the server, the purchase device can purchase a digital product by accessing the server and the installation device can receive the digital product purchased by the purchase device. Although it is not illustrated in FIG. 6, after acquiring the access right from the server, the purchase device can access the server through the MAC address authentication of the purchase device. More specifically, when the purchase device acquiring the access right from the server attempts to access the server again, the server sends a request of the MAC address to the purchase device. When the purchase device receiving the requested MAC address sends its MAC address to the server, the server receives the MAC address from the purchase device and compares it with the device information stored to its database. When the device information pre-stored to the database of the server matches the MAC address of the purchase device, the server immediately grants the access right to the purchase device. That is, upon obtaining the access right from the server through the initial MAC address and user authentication, the purchase device intending to access the server again can acquire the access right through the MAC address authentication.

The purchase device acquiring the access right from the server purchases at least one digital product stored to the server in block 603. Herein, the digital product indicates any product the server can sell online. For example, the digital product can include various contents and applications. The market is the integrated market as aforementioned. In the market, any digital product can be purchased and installed regardless of the type and the platform of the device. For example, the user can purchase and install a smart phone application, smart television application, and PC application to the installation device. In more detail, the smart phone can purchase a smart television application in the integrated market and install the purchased television application to the smart television of another user.

In block 604, the user searches for and selects the user of the installation device to install the digital product purchased by the purchase device. For example, the user can search for and select the user of the installation device stored to at least one of the phone book list and the social network of the purchase device. That is, the user of the installation device can be selected from the users stored to the phone book list stored to the purchase device or the social network of the purchase device.

In block 605, the purchase device receives the installation device information from the server. Since the installation device is also stored to the database of the server, the server can transmit the installation device information to the purchase device. Herein, the installation device information indicates the information relating to the hardware specifications, the version, the platform, and the type of the installation device.

In block 606, the user of the purchase device determines whether the digital product purchased by the purchase device is suitable for the installation device. That is, the user of the purchase device can confirm the hardware specifications, the version, the platform, and the type of the installation device by receiving the installation device information from the server, and determine whether its purchased digital product is suitable for the installation device. When the digital product purchased by the purchase device is not suitable for the installation device, it may be impossible to install the digital product purchased by the purchase device to the installation device.

When the digital product purchased by the purchase device is suitable for the installation device, the user of the purchase device requests the server to transmit the digital product to the installation device in block 607. When the purchase device requests the server to transmit the digital product to the installation device, this process is finished. When the digital product purchased by the purchase device is not suitable for the installation device, the digital product is not installed to the installation device and the process is finished.

Although it is not illustrated in FIG. 6, the integrated market is interoperated with the existing online market. In detail, when the purchase device accesses the server, the server provides the purchase device with not only the digital products stored to the integrated market but also a list of the digital products stored to the existing online market. Hence, the purchase device can purchase the digital products stored to the integrated market and the digital products stored to the existing online market. When the purchase device purchases a digital product stored to the existing online market, the server receives the purchased digital product of the purchase device from the existing online market server. Next, the digital product is installed to the installation device in the same manner as explained above.

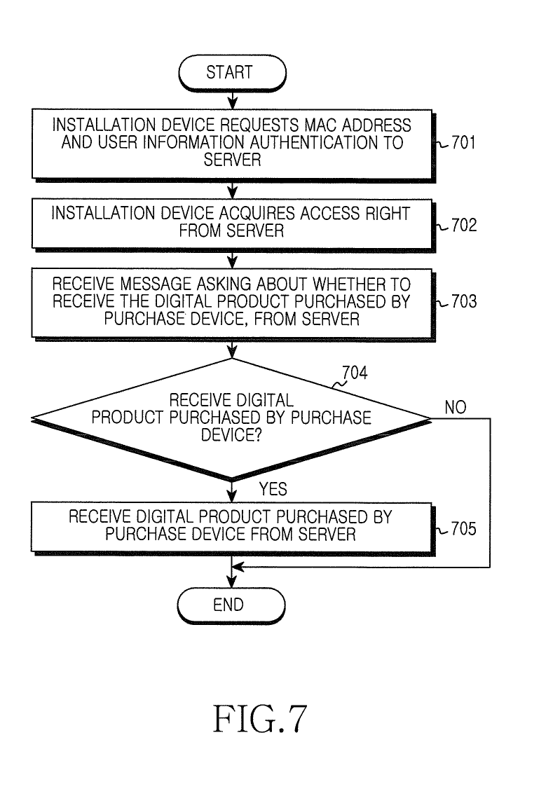

FIG. 7 illustrates operations of the installation device for installing the digital product according, to an embodiment of the present disclosure. As shown in FIG. 7, the installation device requests the MAC address and user information authentication to the server in block 701. In detail, to access the server, the device should pass through an authentication. Herein, the MAC address and user information authentication of the installation device are used. Herein, the installation device is the device which receives the digital product purchased by the purchase device via the server.

In block 702, the installation device acquires the access right from the server. Next, regardless of the access to the server, the installation device can receive the digital product from the purchase device.

In block 703, the installation device receives the message asking about whether to receive the digital product purchased by the purchase device, from the server. More specifically, when the purchase device purchases the digital product stored to the server and requests to install the digital product to the installation device through a certain procedure, the server sends the message relating to the reception before transmitting the digital product to the installation device.

The installation device receiving from the server the message asking about whether to receive the digital product purchased by the purchase device, receives an inquiry about whether to receive the digital product purchased by the purchase device from the server in block 704. Though the server conducts the mutual authentication, the installation device may not want to receive the digital product purchased by the purchase device. That is, the server gives the installation device an option to receive the digital product.

When the installation device receiving from the server the message asking about whether to receive the digital product purchased by the purchase device sends a message indicating the reception to the server, it receives the digital product purchased by the purchase device from the server in block 705. Next, this process of the installation device for installing the digital product is finished. When the server receives from the installation device a message indicating no reception of the digital product purchased by the purchase device, the server does not transmit the digital product to the installation device and the process of the installation device for installing the digital product is finished right away.

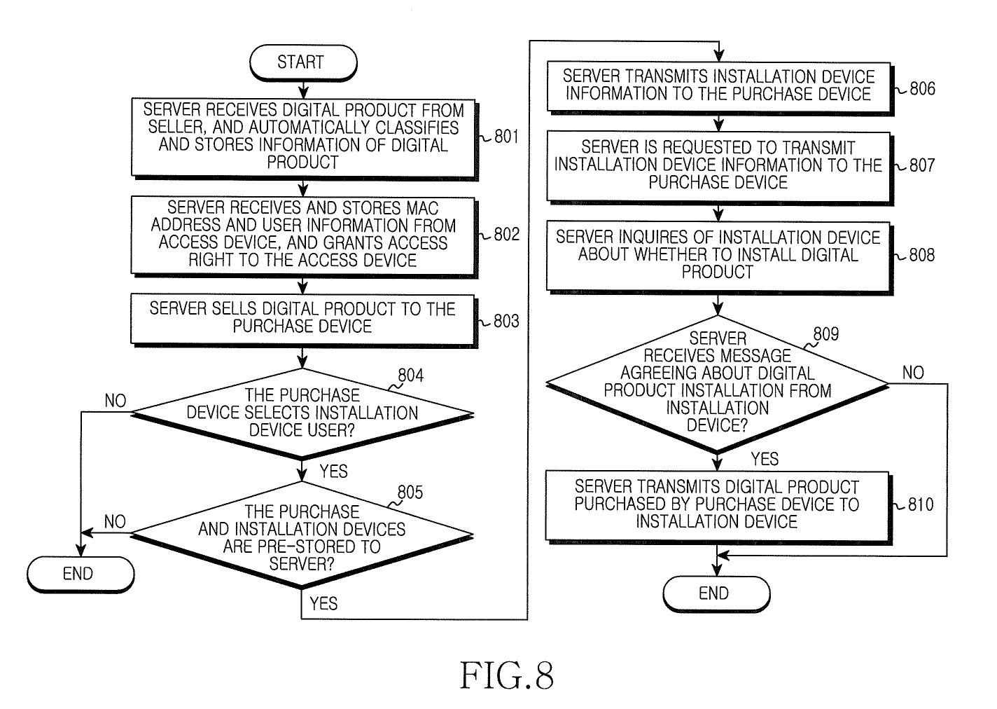

FIG. 8 illustrates operations of the server for installing the digital product according to an embodiment of the present disclosure. As shown in FIG. 8, the server receives the digital product from the seller, and automatically classifies and stores information of the digital product in block 801. In detail, the seller of the digital product uploads the digital product to the server. Next, the server receiving the digital product from the seller automatically classifies and stores the information of the received digital product. That is, the server classifies and stores the digital product to its database. More specifically, the server examines an environment for executing the digital product using an emulator. Herein, the environment for executing the digital product indicates the hardware specifications, the version, the platform type, and the device type of the digital product received from the seller. As such, the server receives the digital product from the seller, and automatically classifies and stores the information of the received digital product.

In block 802, the server receives and stores the MAC address and the user information from the access device, and grants the access right to the access device. In detail, the access device trying to initially access the server should pass through the authentication of the server. Herein, the access device is authenticated using the MAC address and the user information of the access device. Next, the server stores the MAC address and the user information of the access device to its database, and grants the access right to the access device.

Although it is not illustrated in FIG. 8, after acquiring the access right from the server, the access device can access the server through its MAC address authentication. More specifically, when the access device acquiring the access right from the server tries to access the server again, the server requests the MAC address to the access device. When the access device requested the MAC address sends its MAC address to the server, the server receives the MAC address from the access device and compares it with the device information pre-stored to its database. When the device information pre-stored to the database of the server matches the MAC address of the access device, the server immediately grants the access right to the access device. That is, once the access server obtains the access right from the server through the initial MAC address and user authentication, the access device trying to access the server again can obtain the access right through the MAC address authentication.

In block 803, the server sells the digital product to the purchase device. The digital product stored to the server indicates the product received from the seller. That is, the server receives the digital product from the seller and sells the digital product to the purchase device which intends to buy the received digital product.

In block 804, the server determines whether the purchase device selects the user of the installation device. Preferably, since the purchase device is accessing the server, the server can confirm that the purchase device selects the user of the installation device. For example, the purchase device can search for and select the installation device user pre-stored to at least one of the phone book list and the social network of the purchase device. That is, the purchase device can select the installation device user from the users pre-stored to the phone book list and the social network of the purchase device.

Upon confirming that the purchase device selects the user of the installation device, the server determines whether the purchase and installation devices are stored therein in block 805. That is, the server conducts the mutual authentication of the purchase and installation devices. The mutual authentication determines whether the purchase device and the installation device each pre-store the user of the installation device and the user of the purchase device respectively. For example, the mutual authentication determines whether at least one of the phone book list and the social network of the purchase device pre-stores the user of the installation device, and determines whether at least one of the phone book list and the social network of the installation device pre-stores the user of the purchase device. The server conducts the mutual authentication in order to prevent the unilateral digital product installation from the purchase device to the installation device. When the server does not perform the mutual authentication, the installation device may receive an unintended digital product. Thus, in some embodiments, the mutual authentication is important.

Upon completing the mutual authentication, the server transmits the information of the installation device to the purchase device in block 806. In detail, since the installation device is also stored to the database of the server, the server can transmit the information of the installation device to the purchase device. Herein, the installation device information indicates the information relating, to the hardware specifications, the version, the platform, and the type of the installation device. Next, the user of the purchase device determines whether the digital product purchased by the purchase device is suitable for the installation device. That is, the user of the purchase device can obtain the hardware specifications, the version, the platform, and the type of the installation device by receiving the installation device information from the server, and determine whether its purchased digital product is suitable for the installation device. When the digital product purchased by the purchase device is not suitable for the installation device, it may be impossible to install the digital product purchased by the purchase device to the installation device.

When the user of the purchase device receives the installation device information and determines that its purchased digital product is suitable for the installation device, the purchase device requests the server to transmit the digital product purchased by the purchase device to the installation device in block 807. The server finally receives the installation request from the purchase device.

In block 808, the server inquires of the installation device about whether to install the digital product, which prevents the installation device from receiving the unintended digital product, though the server performs the mutual authentication on the purchase and installation devices.

In block 809, the server determines whether the message agreeing about the digital product installation is received from the installation device. When the installation device cannot currently install the digital product, the server does not proceed to the next operation until it receives the message agreeing about the digital product installation from the installation device. For example, the installation device cannot currently install the digital product when the installation device is turned off.

Upon receiving the message agreeing about the digital product installation from the installation device, the server transmits the digital product purchased by the purchase device to the installation device in block 810. When the server transmits the digital product purchased by the purchase device to the installation device, this process is finished. When the mutual authentication is not fulfilled or the server does not receive the message agreeing about the digital product installation from the installation device, this process is also finished.

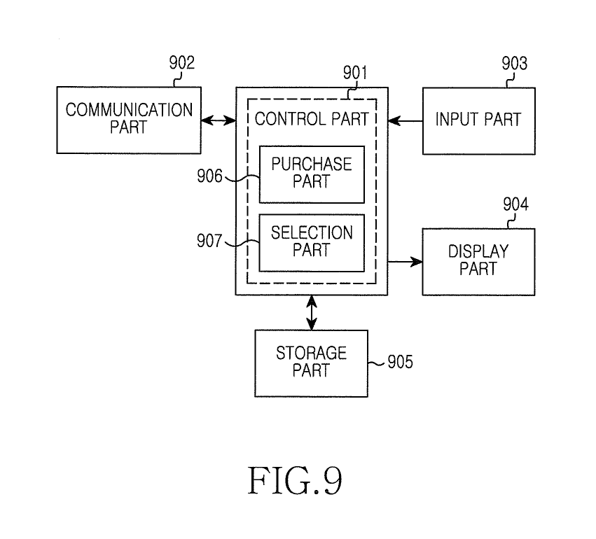

FIG. 9 is a block diagram of a device for purchasing and installing the digital product according, to an embodiment of the present disclosure. As shown in FIG. 9, the device for purchasing, and installing the digital product includes a control part 901, a communication part 902, an input part 903, a display part 904, and a storage part 905.

The control part 901 controls the operations of the device. The control part 901 can include a purchase part 906 and a selection part 907.

The purchase part 906 accesses the server, purchases at least one digital product stored to the server, and purchases at least one digital product stored to another server.

The selection part 907 searches for and selects the at least one second device user to install the purchased digital product, and selects at least one second device to install the purchased digital product. The selection part 907 searches for and selects the second device user stored to at least one of the phone book list and the social network of the first device.

The communication part 902 requests the server to transmit the purchased digital product to the at least one second device, requests the server to authenticate the MAC address and the user information of the first and second devices, and acquires the access right from the server. After the server authenticates the MAC address and the user information of the first and second devices, the first and second devices try to access the server, receive the MAC address request from the server, transmit their MAC address to the server, and acquire the access right from the server. The communication part 902 receives at least one second device information from the server, and receives the digital product lists stored to the server and the other server from the server.

The input part 903 provides input data generated by the user's selection to the control part 901.

The display part 904 displays state information of the device, a menu screen, and information under the control of the control part 901. For example, the display part 904 may include a touch screen.

The storage part 905 can include a program storage for storing a program to control the device, and a data storage for storing data generating in the program execution.

As constructed above, the control part 901 can process the functions of the device. The components are separately provided to distinguish their functions. Accordingly, in the actual product, the control part 901 can process all or part of the functions of the device.

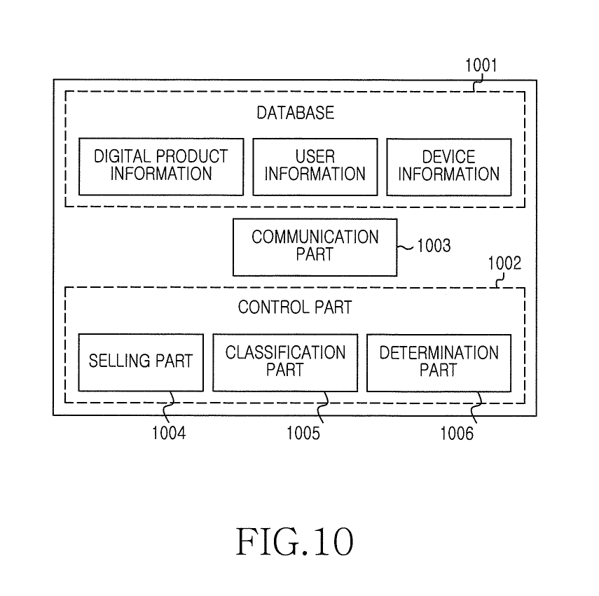

FIG. 10 is a block diagram of a server for installing the digital product according to an embodiment of the present disclosure. As shown in FIG. 10, the server for installing the digital product can include a database 1001 and a control part 1002.

The database 1001 stores the digital product, the user information, and the device information. For example, the database 1001 automatically stores the information of the digital products classified by a classification part, and stores the digital product by automatically examining the hardware specifications, the version, the platform type, and the device type suitable for the digital product. The database 1001 stores the received MAC address and user information.

The control part 1002 controls the operations of the server. The control part 1002 can include a communication part 1003, a selling part 1004, a classification part 1005, and a determination part 1006.

The communication part 1003 transmits the digital product sold to the second device, receives the digital product from at least one seller, receives the MAC addresses and the user information of the first and second devices from the first and second devices, and grants the access right to the first and second devices. The communication part 1003 receives the access request from the first and second devices, requests the MAC address to the first and second devices, receives the MAC addresses from the first and second devices, and grants the access right to the first and second devices when the received MAC address is the pre-stored device information. When determining that the first and second devices are pre-stored to the server, the communication part 1003 transmits the information of the at least one second device to the first device.

When determining that the first and second device users are pre-stored mutually to the first and second devices, the communication part 1003 transmits the at least one second device information to the first device. The communication part 1003 inquires of the second device about whether to transmit the digital product to the second device. When receiving, the message indicating the digital production reception from the second device, the communication part 1003 transmits the digital product to the second device. When the first device accessing the server purchases at least one digital product stored to the other server, the communication part 1003 receives the at least one digital product purchased by the first device from the other server and transmits the received at least one digital product to the second device.

The selling part 1004 sells at least one of the digital products stored to the server, to the first device.

The classification part 1005 classifies the digital products by automatically examining the hardware specifications, the version, the platform type, and the device type suitable for the digital product.

When selecting at least one second device to install the digital product purchased by the first device, the determination part 1006 determines whether the first and second devices are pre-stored to the server. The determination part 1006 determines whether the first and second device users are pre-stored mutually to at least one of a phone book list and a social network of the first and second devices.

As constructed above, the control part 1002 can process the functions of the server. The components are separately provided to distinguish their functions. Accordingly, in the actual product, the control part 1002 can process all or part of the functions of the server.

Embodiments of the present invention according to the claims and description in the specification can be realized in the form of hardware, software or a combination of hardware and software.

Such software may be stored in a computer readable storage medium. The computer readable storage medium stores one or more programs (software modules), the one or more programs comprising instructions, which when executed by one or more processors in an electronic device, cause the electronic device to perform methods of the present invention.

Such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention. Embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the disclosure has been shown and described with reference to certain exemplary embodiments thereof, it will be understood by those skilled in the art that various changes in form and details may be made therein without departing from the spirit and scope of the disclosure as defined by the appended claims and their equivalents.

What is claimed is:

1. An operating method of a first device for purchasing a digital product, comprising:
purchasing at least one digital product stored to a server; and
requesting the server to transmit the purchased digital product to at least one second device.

2. The operating method of claim 1, further comprising:
requesting the server to authenticate Media Access Control (MAC) addresses and user information of the first device and the second device; and
acquiring an access right from the server.

3. The operating method of claim 1, further comprising:
after the server authenticates the MAC addresses and the user information of the first device and the second device, attempting, at the first and second devices, to access the server;
receiving a MAC address request from the server and transmitting the MAC address to the server; and
acquiring the access right from the server.

4. The operating method of claim 1, further comprising:
searching for and selecting a user of the at least one second device to install the purchased digital product;
receiving information of the at least one second device from the server; and
selecting the at least one second device to install the purchased digital product.

5. The operating method of claim 4, wherein the searching for and selecting of the at least one second device user comprises:
searching for and selecting the second device user in at least one of a phone book list and a social network of the first device.

6. The operating method of claim 4, wherein the second device information comprises at least one of: hardware specifications, a version, a platform, and a type of the second device.

7. The operating method of claim 1, wherein the purchasing, at the first device accessing the server, of the at least one digital product stored to the server comprises:
receiving digital product lists stored to the server and another server, from the server; and
purchasing at least one digital product stored to the other server.

8. An operating method of a server for selling a digital product, comprising:
selling at least one of a plurality of digital products stored to the server, to a first device; and
transmitting the digital product to a second device.

9. The operating method of claim 8, further comprising:
receiving the digital product from at least one seller; and
automatically classifying and storing information of the digital product.

10. The operating method of claim 9, wherein the automatic classifying and storing of the digital product information comprises:
classifying and storing the digital product by automatically examining hardware specifications, a version, a platform type, and a device type suitable for the digital product.

11. The operating method of claim 8, further comprising:
receiving Media Access Control (MAC) addresses and user information of the first device and the second device, from the first and second devices;
storing the received MAC addresses and user information; and
granting an access right to the first device and the second device.

12. The operating method of claim 11, further comprising:
receiving an access request from the first and second devices;
requesting the MAC address to the first and second devices and receiving the MAC addresses from the first and second devices; and
when the received MAC addresses are device information pre-stored to the server, granting the access right to the first device and the second device.

13. The operating method of claim 8, further comprising:
when the first device selects at least one second device to install the purchased digital product, determining whether information of the first device and the second device is pre-stored to the server; and
when the information of the first device and the second device is pre-stored to the server, transmitting information of the at least one second device to the first device.

14. The operating method of claim 13, wherein the transmitting of the at least one second device information to the first device comprises:
determining whether at least one of a phone book list and a social network of the first and second devices mutually comprises the first and second device users; and
when the first and second device users are mutually pre-stored to the first and second devices, transmitting the at least one second device information to the first device.

15. The operating method of claim 13, wherein the second device information relates to hardware specifications, a version, a platform, and a type of the second device.

16. The operating method of claim 8, wherein the transmitting of the digital product to the second device comprises:
inquiring of the second device about whether to transmit the digital product to the second device; and
when receiving a message indicating the digital product reception from the second device, transmitting the digital product to the second device.

17. The operating method of claim 8, wherein the selling of at least one of the digital products stored to the server, to the first device comprises:
transmitting digital product lists stored to the server and another server, to the first device accessing the server; and
when the first device purchases at least one digital product stored to the other server, receiving the at least one digital product purchased by the first device, from the other server.

18. An operating method of a second device for installing a digital product, comprising:
receiving a digital product purchased by a first device, from a server; and
receiving and storing the digital product.

19. The operating method of claim 18, further comprising:
receiving from the server a message relating to whether to receive the digital product purchased by the first device; and
transmitting a message agreeing to the reception to the server.

20. An apparatus of a first device for purchasing a digital product, comprising:
a purchase part configured to access a server and purchase at least one digital product stored to the server; and
a communication part configured to requesting the server to transmit the purchased digital product to at least one second device.

21. The apparatus of claim 20, wherein the communication part is configured to request the server to authenticate Media Access Control (MAC) addresses and user information of the first device and the second device, and acquire an access right from the server.

22. The apparatus of claim 20, wherein:
after the server authenticates the MAC addresses and the user information of the first device and the second device, the first and second devices attempt to access the server, and
the communication part receives a MAC address request from the server, transmits the MAC address to the server, and acquires an access right from the server.

23. The apparatus of claim 20, further comprising:
a selection part configured to search for and select a user of the at least one second device to install the purchased digital product, and select the at least one second device to install the purchased digital product,
wherein the communication part is configured to receive information of the at least one second device from the server.

24. The apparatus of claim 23, wherein the selection part is configured to search for and select the second device user in at least one of a phone book list and a social network of the first device.

25. The apparatus of claim 23, wherein the second device information comprises at least one of: hardware specifications, a version, a platform, and a type of the second device.

26. The apparatus of claim 20, wherein the communication part is configured to receive digital product lists stored to the server and another server, from the server, and
the purchase part is configured to purchase at least one digital product stored to the other server.

27. An apparatus of a server for selling a digital product, comprising:
a selling part configured to sell at least one of a plurality of digital products stored to the server, to a first device; and
a communication part configured to transmit the digital product to a second device.

28. The apparatus of claim 27, wherein the communication part receives the digital product from at least one seller, the apparatus further comprising:
a classification part configured to automatically classify information of the digital product; and
a database configured to automatically store the digital product information classified by the classification part.

29. The apparatus of claim 28, wherein the classification part and the database are configured to classify and store the digital product by automatically examining hardware specifications, a version, a platform type, and a device type suitable for the digital product.

30. The apparatus of claim 27, wherein the communication part is configured to receive Media Access Control (MAC) addresses and user information of the first device and the second device, from the first and second devices, and grant an access right to the first second and the second device, the apparatus further comprising:
a database configured to store the MAC addresses and the user information received at the communication part.

31. The apparatus of claim 30, wherein the communication part is configured to receive an access request from the first and second devices, request the MAC address to the first and second devices, receive the MAC addresses from the first and second devices, and grant the access right to the first second and the second device when the received MAC addresses are device information pre-stored to the server.

32. The apparatus of claim 27, further comprising:
a determination part configured to, when the first device selects at least one second device to install the purchased digital product, determine whether the first device and the second device are pre-stored to the server,
wherein, when the first device and the second device are pre-stored to the server, the communication part is configured to transmit information of the at least one second device to the first device.

33. The apparatus of claim 27, wherein the determination part is configured to determine whether at least one of a phone book list and a social network of the first and second devices mutually comprises first and second device users, and
when the first and second device users are mutually pre-stored to the first and second devices, the communication part is configured to transmit the at least one second device information to the first device.

34. The apparatus of claim 27, wherein the second device information comprises at least one of: hardware specifications, a version, a platform, and a type of the second device.

35. The apparatus of claim 27, wherein the communication part is configured to inquire of the second device about whether to transmit the digital product to the second device, and transmit the digital product to the second device when receiving a message indicating the digital product reception from the second device.

36. The apparatus of claim 27, wherein, when the first device accessing the server purchases at least one digital product stored to another server, the communication part receives the at least one digital product purchased by the first device, from the other server, and transmits the received at least one digital product to the second device.
